(19) United States
(12) Patent Application Publication
(10) Pub. No.: US 2010/0232479 A1
(43) Pub. Date: Sep. 16, 2010

(54) WIRELESS TRANSCEIVER

(75) Inventor: Kyeong Jin Kim, Irving, TX (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/443,444

(22) PCT Filed: Sep. 26, 2007
(86) PCT No.: PCT/IB07/02805

§ 371 Date: Apr. 20, 2010

Related U.S. Application Data
(60) Provisional application No. 60/827,537, filed on Sep. 29, 2006.

(51) Int. Cl. H04L 27/28; H04L 27/00; H04B 1/38

(52) U.S. Cl. 375/219; 375/295; 375/316; 375/260

(57) ABSTRACT

Various example embodiments are disclosed relating to wireless transceivers, such as, for example, wireless MIMO (multiple input multiple output) systems. In an example embodiment, a method may include determining an updated channel frequency response (502), and determining a prefilter for use in a wireless MIMO transmitter based on the updated channel frequency response (504) to reduce an error between transmitted and received signals. The prefilter may include a plurality of decomposed channel matrices, at least one of the decomposed channel matrices may have equal diagonal values (such as, for example, an upper triangular matrix R having equal diagonal values). The prefilter may then be used to process or prefilter a received signal for transmission over a wireless channel.

### CROSS-REFERENCE TO RELATED APPLICATION

This application claims priority to U.S. Provisional Application Ser. No. 60/827,537, filed on Sep. 29, 2006, entitled “Wireless Transceiver,” hereby incorporated by reference.

### BACKGROUND

Wireless systems attempt to operate at high spectral efficiency while retaining the limitations on power and bandwidth. Antenna diversity can be exploited to significantly enhance spectral efficiency by using multiple antennas at both transmitter and receiver, which potentially produces multiple parallel data channels, generally called a multiple-input multiple-output (MIMO) channel. The high spectral efficiency associated with the MIMO channel is obtained under the assumption that a rich scattering environment provides independent propagation paths between each pair of transmit and receive antennas.

In a MIMO system, high-rate data transmission may be achieved by dividing the original data stream into several parallel data substreams, each of which is transmitted from a corresponding transmit antenna. All data substreams are typically independent of each other and different data substreams act as interference upon reception. Among those techniques used for high-rate data transmission in wireless environments, Orthogonal Frequency Division Multiplexing (OFDM) is one of the most competitive candidates. Thus, a MIMO-OFDM system can achieve high data rates while providing better system performance by using both antenna diversity and frequency diversity, which makes it attractive for high-data-rate wireless applications.

A number of techniques have been used, including prefiltering, in attempt to improve performance. However, further improved performance is desirable.

### SUMMARY

Various embodiments are disclosed relating to wireless devices and networks, and also relating to wireless transceivers, such as, for example, wireless transceivers for MIMO systems or other systems.

According to an embodiment, a method may include determining an updated channel frequency response, and determining a prefilter for use in a wireless MIMO transmitter based on the updated channel frequency response, the prefilter including a plurality of decomposed channel matrices, at least one of the decomposed channel matrices having equal diagonal values (such as, for example, an upper triangular matrix R having equal diagonal values). In an example embodiment, the determining a prefilter may include determining a prefilter for use in a wireless MIMO transmitter based on the updated channel frequency response to reduce an expected error between a perturbation added vector symbol received at the transmitter and an output variable with perturbation at a receiving wireless node.

In an example embodiment, the determining a prefilter may include: determining a plurality of decomposed channel matrices based on the updated channel frequency response (H), the plurality of decomposed channel matrices including an upper triangular matrix (R) having equal diagonal values, and determining a prefilter for use in a wireless MIMO transmitter, the prefilter including at least: a magnitude scaling diagonal matrix (D), and a lower triangular matrix (E) having diagonal values that are ones.

According to another embodiment, a method is provided including determining an updated channel frequency response for each of a plurality of OFDM subcarriers, determining three decomposed channel matrices based on the updated channel frequency response (H), the three decomposed channel matrices including: an upper triangular matrix (R) having equal diagonal values, a first unitary matrix (Q) and a second unitary matrix (P^{H}), and determining a prefilter for use in a wireless MIMO transmitter based on the updated channel frequency response (H). The prefilter may include at least: a magnitude scaling diagonal matrix (D), and a lower triangular matrix (E) having diagonal values that are ones.

According to another embodiment, a method may include receiving a perturbation added vector symbol, multiplying the perturbation added vector symbol by a magnitude scaling diagonal matrix (D) to generate a magnitude scaled output, multiplying the magnitude scaled output by a matrix (E) (such, for example, as a lower triangular matrix (E)) having diagonal values equal to one to generate an interference added signal, and multiplying the interference added signal by a unitary matrix (Q^{H}) to generate a prefiltered MIMO signal for transmission over a channel.

According to another example embodiment, a method of generating a prefiltered MIMO signal for transmission over a wireless channel may be provided, including determining an updated channel frequency response, determining a prefilter based on the updated channel frequency response, the prefilter including at least a matrix having diagonal values of ones, receiving a perturbation added vector symbol, and prefiltering the perturbation added vector symbol using the prefilter to generate a prefiltered MIMO-OFDM signal for transmission over a channel. In an example embodiment, the prefilter may include at least a lower triangular matrix (E) having diagonal values of ones.

According to another embodiment, an apparatus adapted for use in a wireless MIMO transmitter may be provided. The apparatus may be configured to: determine an updated channel frequency response, and determine a prefilter for use in a wireless MIMO transmitter based on the updated channel frequency response, the prefilter including a plurality of decomposed channel matrices, at least one of the decompose channel matrices having equal diagonal values.

According to another embodiment, an apparatus adapted for use in a wireless MIMO transmitter is provided. The apparatus may be configured to: determine an updated channel frequency response for each of a plurality of OFDM subcarriers, determine three decomposed channel matrices based on the updated channel frequency response (H), the three decomposed channel matrices including: an upper triangular matrix (R) having equal diagonal values, a first unitary matrix (Q), and a second unitary matrix (P^{H}), and determine a prefilter for use in a wireless MIMO transmitter, the prefilter including at least: a magnitude scaling diagonal matrix (D), and a lower triangular matrix (E) having diagonal values that are ones.

According to another embodiment, a wireless MIMO transmitter is provided. The transmitter may include a prefilter configured to receive and prefilter a perturbation added vector symbol, the prefilter including a magnitude scaling diagonal matrix (D) configured to generate a magnitude scaled output based on the perturbation added vector symbol, a lower triangular matrix (E) having diagonal values equal to one configured to generate an interference added signal based on an output of the magnitude scaling diagonal matrix (D), and a unitary matrix (Q^{H}) configured to generate, based on the output of the lower triangular matrix (E), a prefiltered MIMO-OFDM signal for transmission over a channel.

According to another example embodiment, a method may include determining an updated channel frequency response, determining three decomposed channel matrices based on the updated channel frequency response (H), the three decomposed channel matrices including: an upper triangular matrix (R) having equal diagonal values, a first unitary matrix (Q), and a second unitary matrix (P^{H}). The method may also include determining a scaling factor (β). The method may further include the following: receiving a MIMO OFDM signal, multiplying the received MIMO OFDM signal by an inverse of the second unitary matrix (P) to generate a post-filtered MIMO signal, multiplying the post-filtered MIMO signal by the scaling factor (β) to generate a perturbation added decision variable, and performing a modulo function to remove the perturbation from the perturbation added decision variable to generate a decision variable or regenerated vector symbol.

According to another embodiment, a method may include determining an updated channel frequency response, determining a plurality of decomposed channel matrices based on the updated channel frequency response (H), the plurality of decomposed channel matrices including an upper triangular matrix (R) having equal diagonal values, and a unitary matrix (P). The method may also include determining a scaling factor (R), receiving a MIMO OFDM signal, multiplying the received MIMO OFDM signal by the second unitary matrix (P) to generate a post-filtered MIMO signal, multiplying the post-filtered MIMO signal by the scaling factor (β) to generate a perturbation added decision variable, and performing a modulo function to remove the perturbation from the perturbation added decision variable to generate a decision variable or regenerated vector symbol.

According to yet another example embodiment, a wireless MIMO receiver may be provided. The receiver may include, for example, a unitary matrix (P) configured to receive a MIMO OFDM signal via a channel, and to generate a post-filtered MIMO signal, a scaling block configured to multiply the post-filtered MIMO signal by a scaling factor (β) to generate a scaled signal, and a modulo function block configured to remove perturbation from the scaled signal and generate a decision variable or regenerated vector symbol.

The details of one or more implementations are set forth in the accompanying drawings and the description below.

### BRIEF DESCRIPTION OF THE DRAWINGS

FIG. 1 is a block diagram illustrating a wireless network according to an example embodiment.

FIG. 2 is a block diagram of a wireless system according to an example embodiment.

FIG. 3 is a block diagram of a wireless system illustrating subcarrier processing according to an example embodiment.

FIG. 4 is a block diagram illustrating an apparatus that may be provided in a wireless node according to an example embodiment.

FIG. 5 is a flowchart showing a method according to an example embodiment.

FIG. 6 is a flowchart showing a method according to another example embodiment.

FIG. 7 is a flowchart showing a method according to another example embodiment.

FIG. 8 is a flowchart showing a method of generating a prefiltered MIMO signal for transmission over a wireless channel according to another example embodiment.

FIG. 9 is a flowchart showing a method according to another example embodiment.

FIG. 10 is a flowchart showing a method according to another example embodiment.

### DETAILED DESCRIPTION

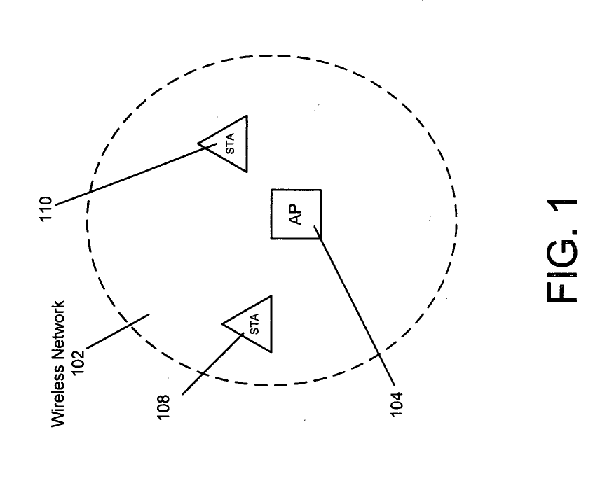

Referring to the Figures in which like numerals indicate like elements, FIG. 1 is a block diagram illustrating a wireless network 102 according to an example embodiment. Wireless network 102 may include a number of wireless nodes or stations, such as an access point (AP) 104 or base station and one or more mobile stations or subscriber stations, such as stations 108 and 110. Each node, AP, station, etc., may include a wireless transceiver, including a wireless transmitter to transmit wireless signals and a wireless receiver to receive wireless signals. While only one AP and two mobile stations are shown in wireless network 102, any number of APs and stations may be provided. Each station in network 102 (e.g., stations 108, 110) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or “device” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various embodiments described herein, and this disclosure is not limited thereto.

As described in greater detail, various details and example embodiments of MIMO-OFDM transceivers are described. The following example notation may be used:
N_{f}, K, N: number of multipaths, subcarriers, and OFDM data symbols in one packet, respectively.
Nₜ, Nᵣ: number of antennas in transmitter and receiver
T_{g}=N_{g}Tₛ, T_{d}=NTₛ, Tₛ: guard time interval, OFDM data symbol interval, and sampling period, respectively.
A, a, (A)_{l,m}, (a)ₖ: a matrix, a vector, the (l,m) element of the matrix A, and the k-th element of a vector a, respectively.
Λ(a₁, a₂, . . . aₖ): a diagonal matrix (non-diagonal values are zero) with diagonal elements of a₁, a₂, . . . , aₖ.
The variables p, q, k, n may be used as indices for transmit antenna, receiver antenna, subcarrier, and OFDM data symbol, respectively, with, for example, 1≦p≦Nₜ, 1≦q≦Nᵣ, 0≦k≦K−1, 1≦n≦N.

Although not required, for the example descriptions of a MIMO transceiver, it may be assumed that, for example:
Multipath delay spread: N_{f}Tₛ≦T_{g}, such that intersymbol interference (ISI) will typically not occur
Channel: a set of channels {hₗ^{p,q}(n)} may be substantially constant over one packet duration, but may vary from packet to packet. The channel between the p-th transmit and the q-th receiver antenna {hₗ^{p,q}(n)}, may be modelled by a tapped delay line, for example.

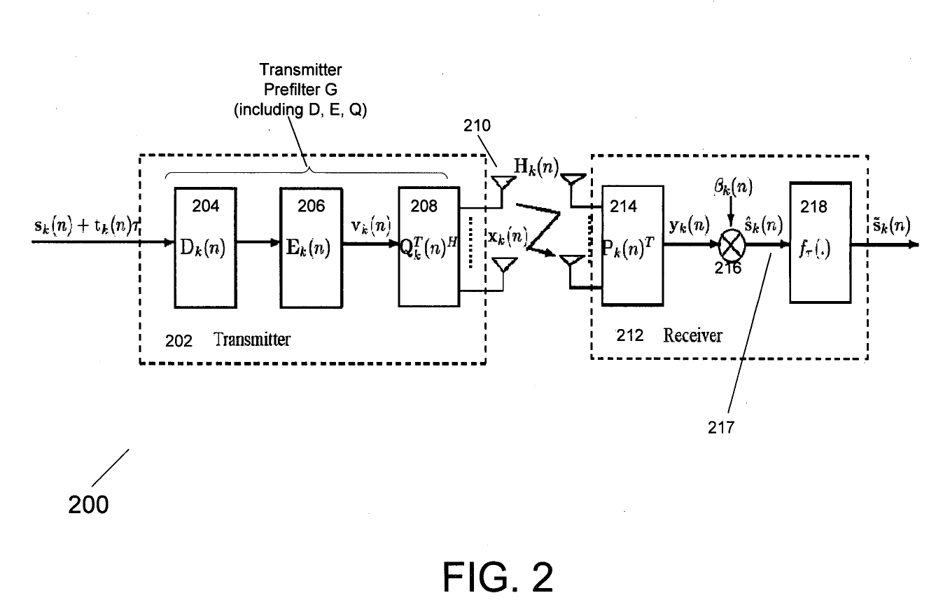

FIG. 2 is a block diagram of a wireless system according to an example embodiment. The wireless system 200 may include a wireless transmitter 202 and a wireless receiver 212, coupled via a wireless channel. In an example embodiment, wireless transmitter 202 may be provided in a first wireless node, while receiver 212 may be provided in a second wireless node, where the first and second wireless nodes may be in wireless communication over a channel. Although not shown, each node may include a wireless transceiver, including both a wireless transmitter (such as transmitter 202) and a wireless receiver (such as receiver 212). A transmitter 202 is shown for a first node and a receiver 212 is shown for a second node, for example, in FIG. 2 as merely a simplified diagram for purposes of explanation.

Transmitter 202 may receive a perturbation added vector symbol as an input (Sₖ(n)+tₖ(n)τ). This may include a vector symbol Sₖ(n) (which may be a column vector), which may include, for example, k subcarrier symbols for each OFDM symbol. A perturbation signal may be added to the received vector symbol, e.g., to reduce the energy of the transmitted signal. The perturbation signal may, for example, include an integer vector perturbation tₖ(n) multiplied times a constant (τ) which may be a positive real value indicating a granularity of perturbation. In an example embodiment, τ may be chosen, for example, as 2(|s|ₘₐₓ+Δ), where |s|ₘₐₓ is a largest absolute magnitude of the constellation symbols (for the modulation scheme that is used) and A is the spacing between constellation symbols.

Transmitter 202 may be transmitting to receiver 212 via a wireless channel having a channel frequency response Hₖ(n). In an example embodiment, Hₖ(n) may represent the frequency responses of all Nᵣ×Nₜ channels at frequency k, and may be represented as a circular Gaussian density, and may introduce noise vector zₖ(n) for each channel.

According to an example embodiment, the channel frequency response Hₖ(n) may be decomposed, e.g., via Geometric Mean Decomposition (GMD) or other technique or algorithm, into a plurality of decomposed matrices. In an example embodiment, the channel frequency response Hₖ(n) may include three decomposed channel matrices, including Q, R and P, which may be represented as:

Hₖ(n)=Qₖ(n)Rₖ(n)Pₖ(n)^{H} eqn. (3),

where superscript H indicates a Hermitian or inverse matrix. This eqn. 3 may be expressed in a simplified form as H=QRP^{H}.

In an example embodiment, Q and P^{H} matrices may be unitary matrices, meaning that Q×Q^{H}=I (identity matrix), and P×P^{H}=I (identity matrix). Matrix Rₖ(n) (or simply written as R) may be a matrix having equal diagonal values, such as an upper triangular matrix having equal diagonal values. Upper triangular may, for example, refer to a matrix having values below the diagonal that are zero, and other values (on the diagonal or above the diagonal) that may be zero or nonzero. A lower triangular matrix may, likewise, refer to a matrix having values above the diagonal which are zero.

Although not required, the use of an R matrix having equal diagonal values may provide a simpler solution, and may increase diversity gain and system performance (e.g., as compared to using an R matrix with non-equal diagonal values), according to an example embodiment. The use of an R matrix having equal diagonal values may cause Q and P matrices to be different (as compared to R matrix having non-equal diagonal values), and based on these changes to Q, P and R, may cause prefilter decomposed matrices D, E and Q (described below) to be different, and thereby improving system performance in some cases.

According to an example embodiment, the matrix R may include values rₖ(n), which may be calculated as the product of singular channel values. For example, R may be calculated according to Eqn. (4) below:

$${r}_{k} ( n ) {=}^{Δ} {( {R}_{k} ( n ) )}_{i , i} = {( {\prod }_{l = 1}^{r} {λ}_{H , l} )}^{1 / r} . \qquad Eqn . ( 4 )$$

Where λ in Eqn. (4) are a set of singular values for the channel frequency response H. After an updated channel frequency response H has been determined or calculated, decomposed channel matrices Qₖ(n), Rₖ(n), and Pₖ(n)^{H} may be determined or calculated based on the updated channel frequency response according to Eqn. (3), for example.

Transmitter 202 may include a prefilter G, which may be designed to minimize or at least to reduce an expected error between a perturbation added vector symbol (e.g., Sₖ(n)+tₖ(n) τ) received at the transmitter 202 and a decision variable with perturbation (e.g., Sₖ(n)hat or Ŝₖ(n) output on line 217) at a receiving wireless node (such as at receiver 212). Thus, the error, which may be desirable to reduce using prefilter G, may be expressed as:

eₖ(n) [symbol] sₖ(n)+tₖ(n)τ−ŝₖ(n) Eqn. (6a)

According to an example embodiment, prefilter G may include decomposed prefilter matrices Dₖ(n), Eₖ(n), and Qₖ(n)^{H}, which may be simply written as matrices D, E and Q, respectively (shown as blocks 204, 206 and 208, respectively, in FIG. 2). Matrix Q^{H} 208 of the prefilter G may be the transposed inverse matrix Q of the channel matrices, and thus may be determined from the channel frequency response Hₖ(n).

Matrix Dₖ(n) 204 may be, for example, a magnitude scaling matrix diagonal matrix, which may be represented as:

Dₖ(n) [symbol] Λ(dₖ¹(n), . . . , dₖ^{N}^{ₜ}(n)) Eqn. (4a)

Matrix Eₖ(n) 206 may be, for example a lower triangular matrix (portion above the diagonal are zeros) having diagonal values that are ones.

According to an example embodiment, matrices D and E may be determined or calculated in accordance with Eqns. (12), below.

$${\tilde{λ}}_{k} ( n ) = \frac{{N}_{r}^{2} {σ}_{n}^{2} {σ}_{τ}^{2} {{r}_{k} ( n )}^{2}}{{( {N}_{r} {σ}_{n}^{2} + {E}_{Tx} {{r}_{k} ( n )}^{2} )}^{2}} , \\ {( {\tilde{β}}_{k} ( n ) )}^{2} = \frac{{N}_{r} {E}_{Tx} {σ}_{τ}^{2} {{r}_{k} ( n )}^{2}}{{( {N}_{r} {σ}_{n}^{2} + {E}_{Tx} {{r}_{k} ( n )}^{2} )}^{2}} , \\ {\tilde{d}}_{k}^{i} ( n ) = \frac{{\tilde{β}}_{k} ( n ) {r}_{k} ( n )}{{\tilde{λ}}_{k} ( n ) + {( {\tilde{β}}_{k} ( n ) )}^{2} {{r}_{k} ( n )}^{2}} , for i = 1 , … , {N}_{r} , \\ {( {( {\tilde{E}}_{k} ( n ) )}^{- 1} )}_{i , j} = \{ \begin{matrix}1 , & if i = j , \\ 0 , & if j > i , \\ {\tilde{β}}_{k} ( n ) {\tilde{d}}_{k}^{i} ( n ) {( {L}_{k} ( n ) )}_{i , j} & if j < i .\end{matrix} \qquad Eqns . ( 12 )$$

According to an example embodiment, λₖ are LaGrange multipliers and may be determined based on rk (values of matrix R), Nᵣ (number of receiver antennas), E_{TX} (transmission power), sigma or σ (a constant). The scaling factor β (which may be used in a receiver to scale a signal to meet an average transmission power constraint) may be calculated as shown in Eqns. (12). The values (dₖ) of magnitude scaling diagonal matrix D may be calculated based on λₖ and scaling factor βₖ as shown in Eqns. (12). Likewise, values for lower triangular matrix E may be calculated based on βₖ, values (dₖ) of matrix D, and matrix Lₖ. Matrix Lₖ=R^{T}, which is the transpose of matrix R.

Prefilter G in transmitter 202 may perform prefiltering on the received perturbation added vector signal, and transmit a signal xₖ(n) over a wireless channel having a channel frequency response Hₖ(n).

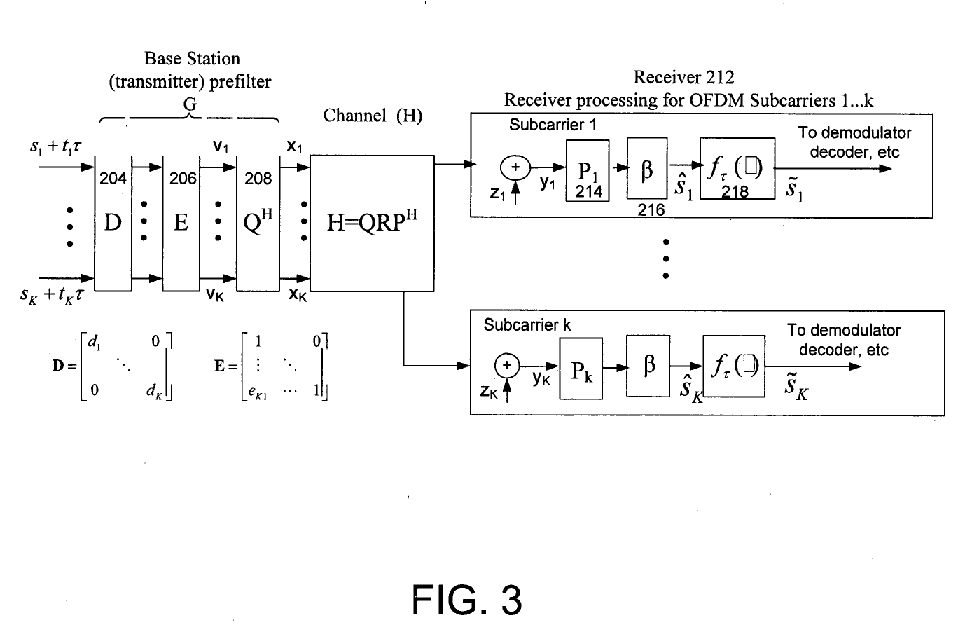

FIG. 3 also illustrates the transmitter 202 including a prefilter G, and the receiver 212, including subcarrier processing at receiver 212 for each of the k OFDM subcarriers, for example. The prefilter G includes matrices D, E and Q, while the channel frequency response H may be calculated as H=QRP^{H}, for example, as shown in FIG. 2.

Referring to FIGS. 2 and 3, the transmitted signal xₖ(n) may be received by a receiver 212. A noise vector zₖ may be added via the channel, and is shown as being added to the received signal. According to an example embodiment, receiver 212 may include a unitary matrix Pₖ(n)^{T}, which is the inverse of the P^{H} matrix (which is one of the channel matrices for H). The received signal may be multiplied by the unitary matrix Pₖ(n)^{T}. However, multiplying the received noise vector z by the unitary matrix Pₖ(n)^{T} at the receiver 212 does not increase the noise due to the unitary nature of P.

After the received signal is multiplied by unitary matrix Pₖ(n)^{T}, a scaling function block (or multiplier) 216 may multiply the output of the P matrix by the scaling factor (β) to generate a perturbation added decision variable, yₖ(n). This scaling factor β may be used to scale the received signal, e.g., to satisfy an average transmission power constraint. An average transmission power constraint may be described by:

E∥xₖ(n)∥²=E_{T}_{ₓ}. Eqn. (4b)

Next, a modulo function block f (.) 218 may perform a modulo function to remove the perturbation added in the transmitter. The modulo function, according to an example embodiment, may be provided based on the following expression:

$${f}_{τ} ( {( z )}_{1} ) = {( z )}_{1} - ⌊ \frac{{( z )}_{1} + τ / 2}{τ} ⌋ \qquad Eqn . ( 5 )$$

Two algorithms will now be briefly described, based on the example system illustrated in FIGS. 2 and 3: I) Updating parameters or values for the transceiver, and II) Processing received signals at the transceiver using the updated parameters or values.

I) Updating Parameters or Values for the Transceiver

1) A transmitter 202, and a receiver (e.g., at different nodes) may determine or calculate an updated channel frequency response H, e.g., for each of a plurality of OFDM subcarriers. This may be determined based on feedback or signals received from another node, for example.

2) Determine three updated decomposed channel matrices R, Q and P^{H} e.g., based on the updated channel frequency response H. For example, an upper triangular matrix R with equal diagonal values, and unitary matrices P^{H} and Q may be calculated according to Eqn. (3), based on updated channel frequency response H.

3) Determine an updated prefilter G for use in a MIMO-OFDM transmitter, e.g., to reduce an expected error between a perturbation added vector symbol received at the transmitter and an output or symbol variable with perturbation at a receiver. The prefilter G may include the three decomposed matrices, such as, the magnitude scaling diagonal matrix D, a lower triangular matrix E having diagonal values of ones, and unitary matrix Q^{H} (where Q is the unitary matrix of the decomposed channel matrices calculated at step 2) above). For example, matrices D and E may be calculated according to Eqns. (12), e.g., by calculating the LaGrange multipliers, the scaling factor β, followed by calculating matrices D and E, for example. These operations may allow a transmitter to update its parameters, e.g., based on changing channel or other changing conditions.

Steps 1)-3) for algorithm I may relate to operations that may be performed by a transmitter or for use by a transmitter. However, similar operations or steps may be performed for a receiver or at another node for use by a receiver, to update or determine updated matrices Q, R and P, and then calculate scaling factor β. Although a receiver may not need to calculate matrices D, E, among other parameters. According to an example embodiment, these new parameters may be calculated or updated every OFDM symbol for every OFDM subcarrier (k), by both the transmitter and/or receiver, for example.

II) Processing Received Signals at the Transceiver Using the Updated Parameters or Values

1) Receive perturbation added vector symbol;

2) multiply the perturbation added vector symbol by the update prefilter G to generate a prefiltered MIMO-OFDM signal for transmission. This may include multiplying the signal by decomposed matrices D, E and QH, as described in sub-operations a-c:
a. multiply the perturbation added vector symbol by a magnitude scaling diagonal matrix (D) to generate a magnitude scaled output;
b. multiply the magnitude scaled output by a matrix (E) having diagonal values equal to one to generate an interference added signal vₖ;
c. multiply the interference added signal by a unitary matrix (Q^{H}) to generate a prefiltered MIMO signal for transmission over a channel.

For example, operations 1) and 2) above of algorithm II may relate to operations that may be performed by a transmitter. The following operations 3)-6) of algorithm II may be performed by a receiver, for example.

3) receive a MIMO OFDM signal at a receiver;

4) multiply the received MIMO OFDM signal by the second unitary matrix (P) to generate a post-filtered MIMO signal;

5) multiply the post-filtered MIMO signal by the scaling factor (β) to generate a perturbation added decision variable; and

6) perform a modulo function to remove the perturbation from the perturbation added decision variable to generate a decision variable or regenerated vector symbol.

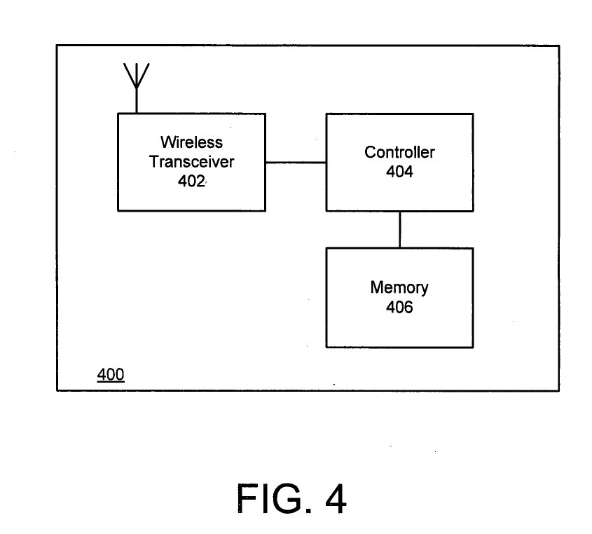

FIG. 4 is a block diagram illustrating an apparatus 400 that may be provided in a wireless node according to an example embodiment. The wireless node (e.g. station or AP) may include, for example, a wireless transceiver 402 to transmit and receive signals, a controller 404 to control operation of the station and execute instructions or software, and a memory 406 to store data and/or instructions.

Controller 404 may be programmable and capable of executing software or other instructions stored in memory or on other computer media to perform the various tasks and functions described above, such as one or more the tasks or methods described above in FIGS. 1-3.

In addition, a storage medium may be provided that includes stored instructions, when executed by a controller or processor that may result in the controller 404, or other controller or processor, performing one or more of the functions or tasks described above.

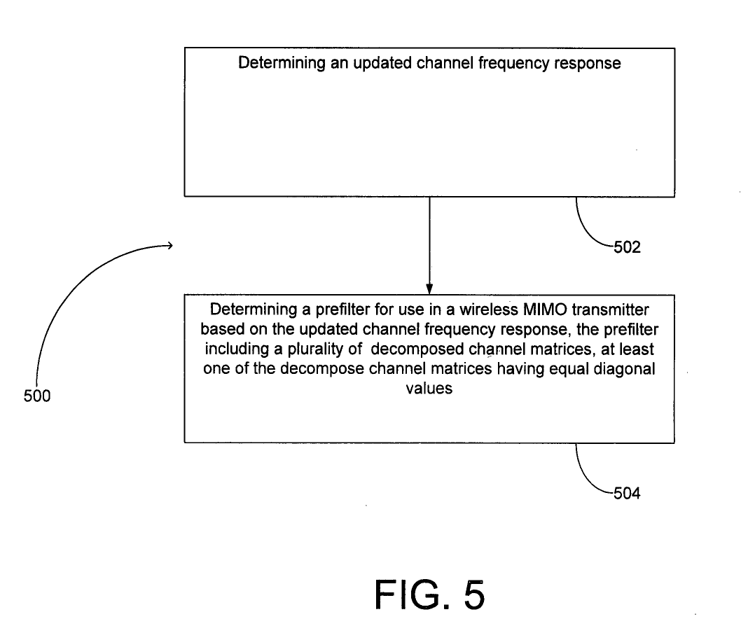

FIG. 5 is a flowchart showing a method 500 according to an example embodiment. According to this example, the method 500 may include determining an updated channel frequency response (502). The method 500 may further include determining a prefilter for use in a wireless MIMO transmitter based on the updated channel frequency response (504). The prefilter may include a plurality of decomposed channel matrices. At least one of the decomposed channel matrices may have equal diagonal values.

According to an example embodiment, the determining the updated channel frequency response may comprise determining an updated channel frequency response for each of a plurality of OFDM subcarriers based on feedback received from one or more other wireless nodes.

According to another example embodiment, the determining the prefilter may comprise determining a prefilter based on the updated channel frequency response to reduce signal error for a wireless MIMO transmitter that receives a perturbation added vector symbol as an input.

According to another example embodiment, the determining the prefilter may comprise determining a prefilter for use in a wireless MIMO transmitter based on the updated channel frequency response to reduce an expected error between a perturbation added vector symbol received at the transmitter and an output variable with perturbation at a receiving wireless node.

According to another example embodiment, the determining the prefilter may comprise determining a plurality of decomposed channel matrices based on the updated channel frequency response (H), the plurality of decomposed channel matrices including an upper triangular matrix (R) having equal diagonal values. In this example, determining the prefilter may further comprise determining a prefilter for use in a wireless MIMO transmitter. The prefilter for use in a wireless MIMO transmitter may include at least a magnitude scaling matrix (D) and a lower triangular matrix (E) having diagonal values that are ones.

According to another example embodiment, the determining the prefilter may comprise determining three decomposed channel matrices based on the updated channel frequency response H. The three decomposed channel matrices may include an upper triangular matrix (R) having equal diagonal values, a first unitary matrix (Q), and a second unitary matrix (P^{H}). In this example, determining the prefilter may further comprise determining a prefilter for use in a wireless MIMO transmitter. The prefilter for use in the wireless MIMO transmitter may include at least a magnitude scaling diagonal matrix (D) and a lower triangular matrix (E) having diagonal values that are ones.

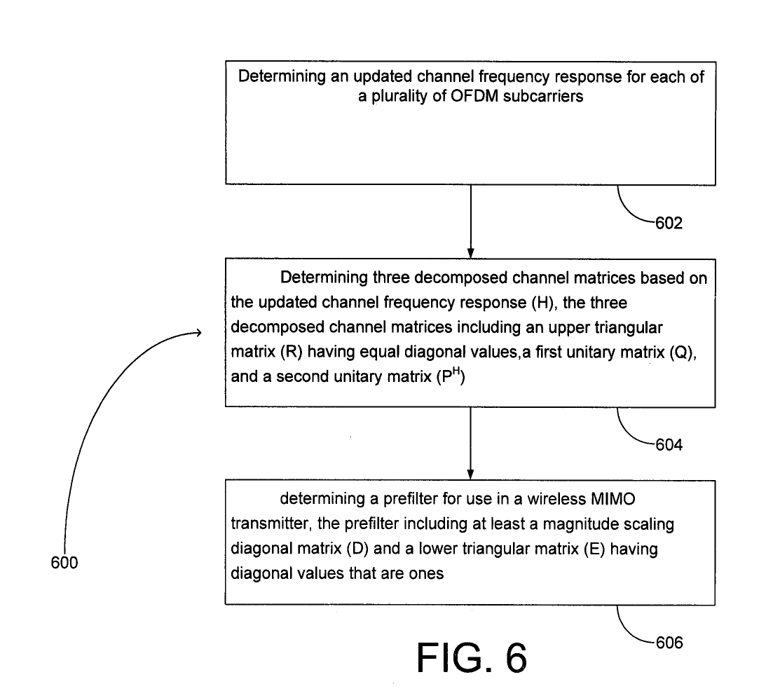

FIG. 6 is a flowchart showing a method 600 according to another example embodiment. In this example, the method 600 may include determining an updated channel frequency response for each of a plurality of OFDM subcarriers (602). The method 600 may also include determining three decomposed channel matrices based on the updated channel frequency response (H) (604). The three decomposed channel matrices may include an upper triangular matrix (R) having equal diagonal value, a first unitary matrix (Q), and a second unitary matrix (P^{H}). In this example, the method 600 may further include determining a prefilter for use in a wireless MIMO transmitter (606). The prefilter may include at least a magnitude scaling diagonal matrix (D) and a lower triangular matrix (E) having diagonal values that are ones.

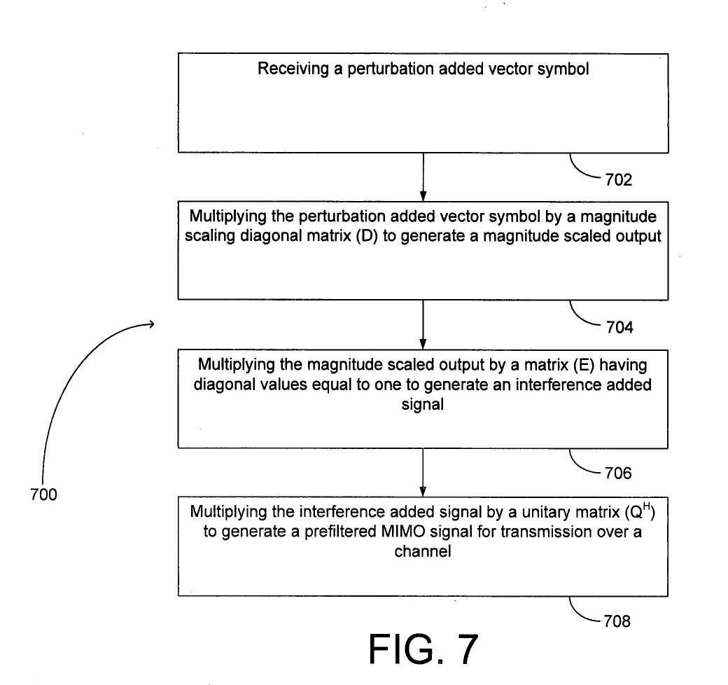

FIG. 7 is a flowchart showing a method 700 according to another example embodiment. According to this example, the method 700 may include receiving a perturbation added vector symbol (702). The method 700 may further include multiplying the perturbation added vector symbol by a magnitude scaling diagonal matrix (D) to generate a magnitude scaled output (704). The method 700 may further include multiplying the magnitude scaled output by a matrix (E) having diagonal values equal to one to generate an interference added signal (706). The method 700 may further include multiplying the interference added signal by a unitary matrix (QH) to generate a prefiltered MIMO signal for transmission over a channel (708).

According to an example embodiment, the multiplying the magnitude scaled output by a matrix (E) having diagonal values may comprise multiplying the magnitude scaled output by a lower triangular matrix (E) having diagonal values equal to one to generate an interference added signal.

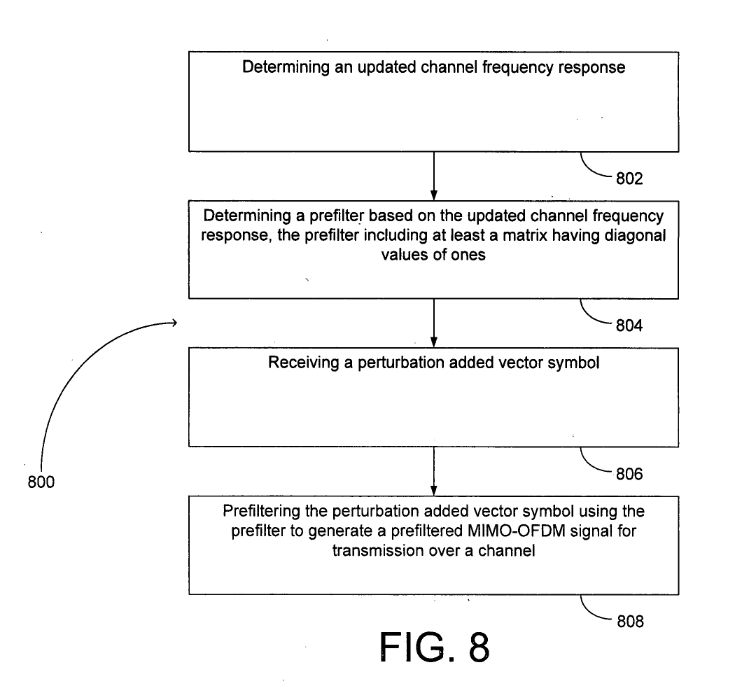

FIG. 8 is a flowchart showing a method 800 of generating a prefiltered MIMO signal for transmission over a wireless channel according to another example embodiment. According to this example, the method 800 may comprise determining an updated channel frequency response (802). The method 800 may further comprise determining a prefilter based on the updated channel frequency response, the prefilter including at least a matrix having diagonal values of ones (804). The method 800 may further comprise receiving a perturbation added vector symbol (806). The method 800 may further comprise prefiltering the perturbation added vector symbol using the prefilter to generate a prefiltered MIMO-OFDM signal for transmission over a channel (808).

According to an example embodiment, the determining the prefilter may comprise determining a prefilter based on the updated channel frequency response, the prefilter including at least a lower triangular matrix (E) having diagonal values of ones.

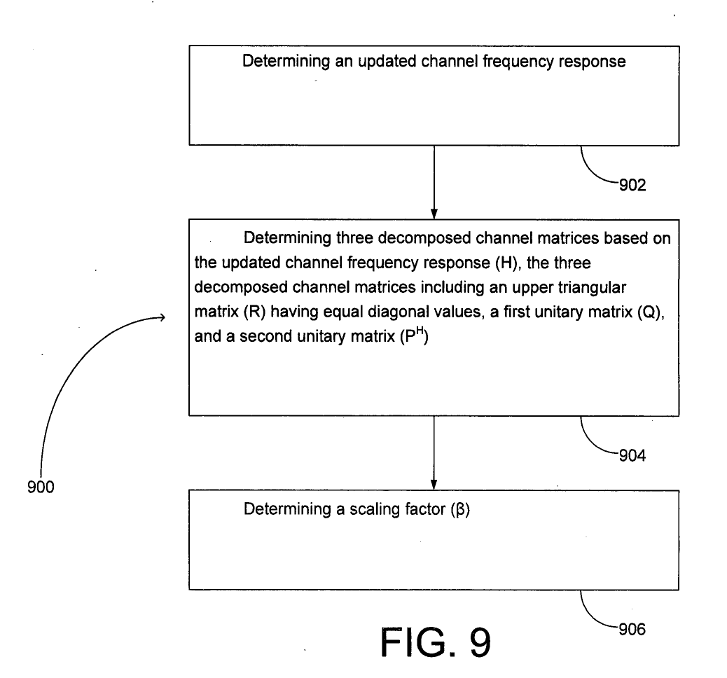

FIG. 9 is a flowchart showing a method 900 according to another example embodiment. The method 900 may include determining an updated channel frequency response (902). The method 900 may further include determining three decomposed channel matrices based on the updated channel frequency response (H) (904). The three decomposed channel matrices may include an upper triangular matrix (R) having equal diagonal values, a first unitary matrix (Q), and a second unitary matrix (P^{H}). The method 900 may further include determining a scaling factor (β) (906).

According to an example embodiment, the method 900 may further include receiving a MIMO OFDM signal. The method 900 may further include multiplying the received MIMO OFDM signal by an inverse of the second unitary matrix (P) to generate a post-filtered MIMO signal. The method 900 may further include multiplying the post-filtered MIMO signal by the scaling factor (β) to generate a perturbation added decision variable. The method 900 may further include performing a modulo function to remove the perturbation from the perturbation added decision variable to generate a decision variable or regenerated vector symbol.

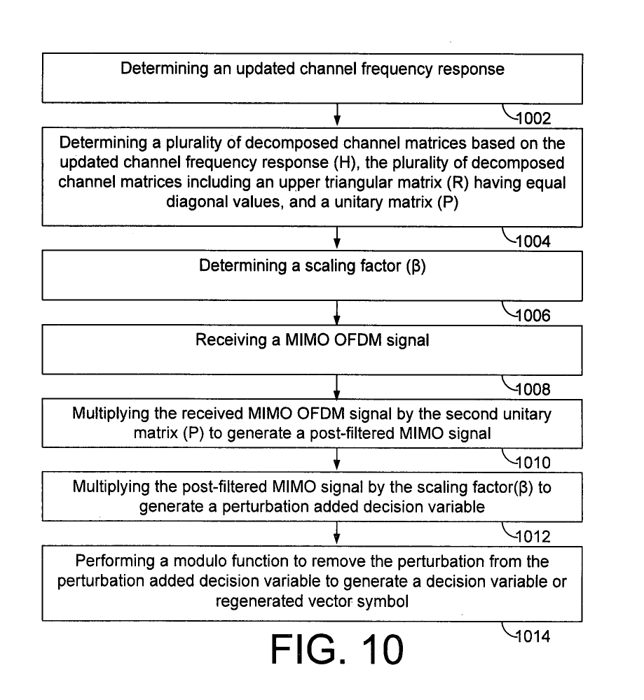

FIG. 10 is a flowchart showing a method 1000 according to another example embodiment. According to this example, the method 1000 may include determining an updated channel frequency response (1002). The method 1000 may further include determining a plurality of decomposed channel matrices based on the updated channel frequency response (H) (1004). The plurality of decomposed channel matrices may include an upper triangular matrix (R) having equal diagonal values and a unitary matrix (P). The method 1000 may further include determining a scaling factor (β) (1006). The method 1000 may further include receiving MIMI OFDM signal (1008). The method 1000 may further include multiplying the received MIMO OFDM signal by the second unitary matrix (P) to generate a post-filtered MIMO signal (1010). The method 1000 may further include multiplying the post-filtered MIMO signal by the scaling factor (β) to generate a perturbation added decision variable (1012). The method 1000 may further include performing a modulo function to remove the perturbation from the perturbation added decision variable to generate a decision variable or regenerated vector symbol (1014).

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

1. A method comprising:
determining an updated channel frequency response (502); and
determining a prefilter for use in a wireless MIMO transmitter based on the updated channel frequency response, the prefilter including a plurality of decomposed channel matrices, at least one of the decomposed channel matrices having equal diagonal values (504).

2. The method according to claim 1 wherein the determining the updated channel frequency response comprises:
determining an updated channel frequency response for each of a plurality of OFDM subcarriers based on feedback received from one or more other wireless nodes.

3. The method according to claim 1 wherein the determining the prefilter comprises:
determining a prefilter based on the updated channel frequency response to reduce signal error for a wireless MIMO transmitter that receives a perturbation added vector symbol as an input.

4. The method according to claim 1 wherein the determining the prefilter comprises:
determining a prefilter for use in a wireless MIMO transmitter based on the updated channel frequency response to reduce an expected error between a perturbation added vector symbol received at the transmitter and an output variable with perturbation at a receiving wireless node.

5. The method according to claim 1 wherein the determining the prefilter comprises:
determining a plurality of decomposed channel matrices based on the updated channel frequency response (H), the plurality of decomposed channel matrices including an upper triangular matrix (R) having equal diagonal values;
determining a prefilter for use in a wireless MIMO transmitter, the prefilter including at least:
a magnitude scaling diagonal matrix (D); and
a lower triangular matrix (E) having diagonal values that are ones.

6. The method according to claim 1 wherein the determining the prefilter comprises:
determining three decomposed channel matrices based on the updated channel frequency response (H), the three decomposed channel matrices including:
an upper triangular matrix (R) having equal diagonal values;
a first unitary matrix (Q); and
a second unitary matrix (P^{H});
determining a prefilter for use in a wireless MIMO transmitter, the prefilter including at least:
a magnitude scaling diagonal matrix (D); and
a lower triangular matrix (E) having diagonal values that are ones.

7. A method comprising:
determining an updated channel frequency response for each of a plurality of OFDM subcarriers (602); and
determining three decomposed channel matrices based on the updated channel frequency response (H), the three decomposed channel matrices including:
an upper triangular matrix (R) having equal diagonal values;
a first unitary matrix (Q); and
a second unitary matrix (P^{H}) (604);
determining a prefilter for use in a wireless MIMO transmitter, the prefilter including at least:
a magnitude scaling diagonal matrix (D); and
a lower triangular matrix (E) having diagonal values that are ones (606).

8. A method comprising:
receiving a perturbation added vector symbol (702);
multiplying the perturbation added vector symbol by a magnitude scaling diagonal matrix (D) to generate a magnitude scaled output (704);
multiplying the magnitude scaled output by a matrix (E) having diagonal values equal to one to generate an interference added signal (706);
multiplying the interference added signal by a unitary matrix (Q^{H}) to generate a prefiltered MIMO signal for transmission over a channel (708).

9. The method according to claim 8 wherein the multiplying the magnitude scaled output by a matrix (E) having diagonal values comprises:
multiplying the magnitude scaled output by a lower triangular matrix (E) having diagonal values equal to one to generate an interference added signal.

10. A method of generating a prefiltered MIMO signal for transmission over a wireless channel comprising:
determining an updated channel frequency response (802);
determining a prefilter based on the updated channel frequency response, the prefilter including at least a matrix having diagonal values of ones (804);
receiving a perturbation added vector symbol (806);
prefiltering the perturbation added vector symbol using the prefilter to generate a prefiltered MIMO-OFDM signal for transmission over a channel (806).

11. The method according to claim 10 wherein the determining a prefilter comprises:
determining a prefilter based on the updated channel frequency response, the prefilter including at least a lower triangular matrix (E) having diagonal values of ones.

12. An apparatus adapted for use in a wireless MIMO transmitter (202), the apparatus configured to:
determine an updated channel frequency response; and
determine a prefilter for use in a wireless MIMO transmitter based on the updated channel frequency response, the prefilter including a plurality of decomposed channel matrices, at least one of the decompose channel matrices having equal diagonal values.

13. An apparatus adapted for use in a wireless MIMO transmitter (202), the apparatus configured to:
determine an updated channel frequency response for each of a plurality of OFDM subcarriers; and
determine three decomposed channel matrices based on the updated channel frequency response (H), the three decomposed channel matrices including:
an upper triangular matrix (R) having equal diagonal values;
a first unitary matrix (Q); and
a second unitary matrix (P^{H});
determine a prefilter for use in a wireless MIMO transmitter, the prefilter including at least:
a magnitude scaling diagonal matrix (D); and
a lower triangular matrix (E) having diagonal values that are ones.

14. A wireless MIMO transmitter (202) comprising:
a prefilter configured to receive and prefilter a perturbation added vector symbol, the prefilter including:
a magnitude scaling diagonal matrix (D) (204) configured to generate a magnitude scaled output based on the perturbation added vector symbol;
a lower triangular matrix (E) (206) having diagonal values equal to one configured to generate an interference added signal based on an output of the magnitude scaling diagonal matrix (D); and
a unitary matrix (Q^{H}) (208) configured to generate, based on the output of the lower triangular matrix (E), a prefiltered MIMO-OFDM signal for transmission over a channel.

15. A method comprising:
determining an updated channel frequency response (902);
determining three decomposed channel matrices based on the updated channel frequency response (H), the three decomposed channel matrices including:
an upper triangular matrix (R) having equal diagonal values;
a first unitary matrix (Q); and
a second unitary matrix (P^{H}) (904);
determining a scaling factor (β) (906).

16. The method according to claim 15 and further comprising:
receiving a MIMO OFDM signal;
multiplying the received MIMO OFDM signal by an inverse of the second unitary matrix (P) to generate a post-filtered MIMO signal;
multiplying the post-filtered MIMO signal by the scaling factor (β) to generate a perturbation added decision variable; and
performing a modulo function to remove the perturbation from the perturbation added decision variable to generate a decision variable or regenerated vector symbol.

17. A method comprising:
determining an updated channel frequency response (1002);
determining a plurality of decomposed channel matrices based on the updated channel frequency response (H), the plurality of decomposed channel matrices including an upper triangular matrix (R) having equal diagonal values, and a unitary matrix (P) (1004);
determining a scaling factor (β) (1006);
receiving a MIMO OFDM signal (1008);
multiplying the received MIMO OFDM signal by the second unitary matrix (P) to generate a post-filtered MIMO signal (1010);
multiplying the post-filtered MIMO signal by the scaling factor (β) to generate a perturbation added decision variable (1012); and
performing a modulo function to remove the perturbation from the perturbation added decision variable to generate a decision variable or regenerated vector symbol (1014).

18. A wireless MIMO receiver (212) comprising:
a unitary matrix (P) configured to receive a MIMO OFDM signal via a channel, and to generate a post-filtered MIMO signal (214);
a scaling block configured to multiply the post-filtered MIMO signal by a scaling factor (β) to generate a scaled signal (216); and
a modulo function block configured to remove perturbation from the scaled signal and generate a decision variable or regenerated vector symbol (218).
